(19) United States
(12) Patent Application Publication
(10) Pub. No.: US 2015/0256917 A1
(43) Pub. Date: Sep. 10, 2015

(54) COMPONENT HAVING A MICROPHONE AND MEDIA SENSOR FUNCTION

(71) Applicant: Robert Bosch GmbH, Stuttgart (DE)

(72) Inventors: Christoph SCHELLING, Stuttgart (DE); Benedikt STEIN, Karlsruhe (DE); Martina REINHARDT, Karlsruhe (DE); Rolf SCHEBEN, Stuttgart (DE); Ricardo EHRENPFORDT, Korntal-Muenchingen (DE)

(21) Appl. No.: 14/637,069

(22) Filed: Mar. 3, 2015

(30) Foreign Application Priority Data
Mar. 4, 2014 (DE) 10 2014 203 881.2

(51) Int. Cl. H04R 1/08; H04R 3/00

(52) U.S. Cl. CPC H04R 1/08; H04R 3/00; H04R 2201/003

(57) ABSTRACT

A concept is provided for the cost-effective and space-saving implementation of multisensor modules having a high-quality acoustic microphone function and having at least one further sensor function which requires a media application. A component of this type includes at least one MEMS microphone element which is mounted inside a housing across at least one sound opening formed in the housing wall so that the sound pressure application of the microphone structure of the MEMS microphone element takes place via this sound opening and the housing interior functions as the back side volume for the microphone structure. At least one leakage path is formed in the microphone structure for a slow pressure equalization between the front side and the back side of the microphone structure. At least one further MEMS sensor element is situated within the housing, whose sensor function requires a media application.

### FIELD OF THE INVENTION

The present invention relates to a component having at least one MEMS microphone element, which is mounted inside a housing across at least one sound opening in the housing wall so that the sound pressure application of the microphone structure of the MEMS microphone element takes place via this sound opening and the housing interior functions as a back volume for the microphone structure, at least one leakage path being formed in the microphone structure for a slow pressure equalization between the front side and the back side of the microphone structure.

### BACKGROUND INFORMATION

A microphone component of this type is described in publication U.S. Pat. No. 7,166,910. It includes a MEMS microphone element having a diaphragm structure which is formed in the element top side and spans a cavern in the element back side. With regard to the implementation of the MEMS microphone element, reference is made in U.S. Pat. No. 7,166,910 to U.S. Pat. No. 5,870,482, where micromechanical microphone structures including a leakage path for slow pressure equalization between the two sides of the microphone diaphragm are provided. In the component known from U.S. Pat. No. 7,166,910, the MEMS microphone element is situated inside a housing having a housing bottom and a housing cover which are connected to each other in a pressure-tight manner via side parts. The housing bottom is designed for the assembly and electrical contacting of the component on the 2nd level, thus for example on the printed circuit board of a piece of terminal equipment. The sound opening of the housing is situated in the housing cover. The MEMS microphone element is mounted on the inner side of the housing cover in a pressure-tight manner across the sound opening so that sound pressure is applied to the diaphragm structure via the back side cavern and the entire space within the housing functions as a back volume for the microphone element.

The known microphone component includes, in addition to the MEMS microphone element, an amplifier element, which is likewise situated within the housing, preferably on the housing bottom.

### SUMMARY

The present invention provides a concept for the cost-effective and space-saving implementation of multi-sensor modules having a high-grade acoustic microphone function and having at least one additional sensor function which requires a media application.

According to the present invention, in addition to the MEMS microphone element, at least one further MEMS sensor element is situated within the housing, whose sensor function requires a media application, namely in such a way that this media application takes place via the at least one leakage path in the microphone structure of the MEMS microphone element.

The component concept according to the present invention provides that the entire housing interior be used as a back volume for the microphone structure of the MEMS microphone element in order to thus optimize the microphone performance The assembly of the MEMS microphone element across the sound opening of the housing, required for this purpose, does not necessarily exclude a media exchange between the housing interior and component surroundings. A good signal-to-noise ratio of the microphone function even requires a slow pressure equalization between the two sides of the microphone structure so that leakage paths specifically for this are formed in the microphone structure. According to the present invention, it is provided that the media exchange between the component surroundings and the housing interior, which takes place via these leakage paths in the microphone structure, be used for further sensor functions, such as a pressure sensor, a humidity sensor, or also a gas sensor.

The component concept according to the present invention allows for the development that increasingly more applications, for example in automotive engineering and in the consumer electronics field, require a plurality of sensor functions. The combination of multiple microphone or sensor functions in one component housing is, in general, always more space saving and cost efficient than the implementation of multiple components having only one microphone or sensor function respectively. In addition, the MEMS sensor element is very well protected against outside mechanical influences due to the situation according to the present invention within the otherwise closed component housing.

Basically, there are many different options for implementing the component concept according to the present invention, which is primarily determined by the intended functional scope of the component and its place of installation. Thus, the type and number of element components may be varied as well as the assembly thereof within the housing. The housing itself may also be designed quite differently and adapted in form and material to the particular application. It is, however, essential that the leakage path(s) in the microphone structure ensure(s) a sufficient media application for the particular MEMS sensor function. Response times of the MEMS sensor function in the range of a few seconds, preferably of less than one second, are desirable. The opening cross section of the leakage path(s) must be selected accordingly for this purpose.

In one exemplary embodiment of the present invention, the opening cross section of the at least one leakage path in the microphone structure of the MEMS microphone element is variable so that the media exchange between the component surroundings and the housing interior may be selectively facilitated or increased. For this purpose, the microphone structure includes at least one controllable structure element, with the aid of which a predefined opening cross section of the at least one leakage path is settable. This may be, for example, a bar or web type structure element, which is completely or partially displaceable, e.g., by electrostatic attraction or repulsion, across the opening cross section of the leakage path. In a particularly advantageous specific embodiment of the present invention, the controllable diaphragm of the microphone structure serves for setting the opening cross section of the at least one leakage path. In this case, the same actuator means may be used, with which the diaphragm is also mechanically pretensioned in order to increase the microphone sensitivity, for the control.

Supplementally or also as an alternative to these measures for varying the opening cross section, the pressure equalization flow across the at least one leakage path may also be increased with the aid of controllable structure elements for ventilating and/or by heating means for targeted local heating. The outer dimensions of a component according to the present invention depend not only on the number and size of the individual element components, but also substantially on their arrangement within the housing. Thereby, in addition to the mechanical fixing, a sensible and space-saving electrical contacting of the elements among each other and with the mounting side of the component must always be considered.

In certain constellations, it may be meaningful to mount the MEMS microphone element and the MEMS sensor element next to each other on a housing wall section, for example, the cover part. It is also possible to position the MEMS microphone element and the MEMS sensor element on opposite housing wall sections, for example, the cover part and the housing bottom. In this case, it may be advantageous to arrange the two element components offset to one another.

In addition to the MEMS element components, microphone element, and media sensor element, further element components may also be situated within the component housing. In a preferred specific embodiment, the component according to the present invention also includes at least one ASIC element which is electrically connected to the MEMS microphone element and/or the MEMS sensor element. This ASIC element advantageously serves for processing and evaluating the microphone and sensor signals.

The electrical contacting of the individual element components among each other and with a wiring level on the inner housing wall of the component may be implemented via wire bonds and/or bump contacts. However, at least two elements in the form of a chip stack may also be mounted in the housing and electrically contacted.

### BRIEF DESCRIPTION OF THE DRAWINGS

FIG. 1 shows a schematic sectional view of a first component 100 according to the present invention having a microphone element 10, a media sensor element 30, and two ASIC elements 41, 42.

FIG. 2 shows a schematic sectional view of a second component 200 according to the present invention having a microphone element 10, a media sensor element 30, and only one ASIC element 40.

FIG. 3 shows a schematic sectional view of a third component 300 according to the present invention having a microphone element 10, a gas sensor element 33, a UV diode or an IR heater 50 as a heating means, and two ASIC elements 41, 42.

### DETAILED DESCRIPTION

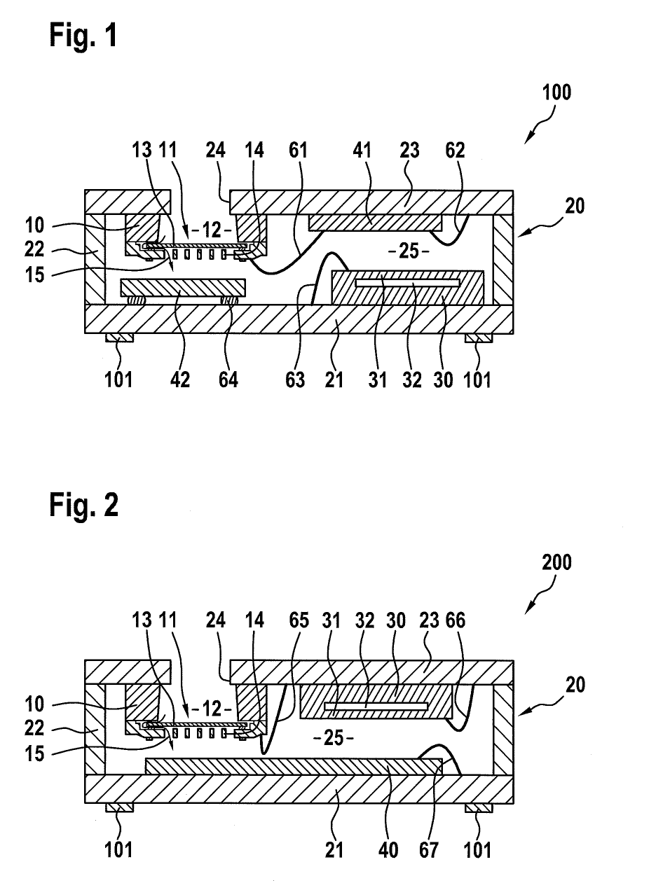

Component 100 illustrated in FIG. 1 includes four element components 10, 30, 41, and 42, which are situated within a housing 20: a MEMS microphone element 10, a further MEMS sensor element, which is designated in the following as media sensor element 30 since its sensor function requires a media application, and two ASIC elements 41, 42.

MEMS microphone element 10 includes a microphone structure 11 having an acoustically active diaphragm 13 and a stationary, acoustically permeable counter element 14. In addition, at least one leakage path 15 is formed in microphone structure 11, in this case illustrated in the form of an arrow 15, via which a slow pressure equalization takes place between the two sides of microphone structure 11. Microphone structure 11 is formed in the element front side and spans a cavern 12 in the element back side.

Media sensor element 30 may be, for example, a pressure sensor element or also a humidity or gas sensor element. In any case, in the front side of media sensor element 30 illustrated here, a diaphragm 31 is formed which spans a closed cavity 32 in the element structure.

An ASIC element 41 or 42 for processing the microphone signals or the sensor signals is respectively assigned to MEMS microphone element 10 and media sensor element 30.

Component housing 20 is made up in this case of a bottom substrate 21, a ring substrate 22, and a cover substrate 23, which are connected to each other in a pressure-tight manner. All three substrates 21, 22, and 23 are preferably duroplastic plastic substrates, e.g., printed circuit boards (PCBs), which are equipped with electrical path structures, conductor paths, and through contacts, so that cover substrate 23 and ring substrate 22 are also electrically connected to bottom substrate 21. In addition, through contacts for the external electrical contacting of component 100 should be provided in bottom substrate 21, since component 100 is mounted on an application printed circuit board via solder lands 101 on the back side of the bottom substrate 21.

A sound opening 24 is formed in cover substrate 23 of housing 20. MEMS microphone element 10 is mounted across this sound opening 24 in a pressure-tight manner. In the exemplary embodiment illustrated here, MEMS microphone element 10 is situated with the element back side on the inner side of cover substrate 23, so that sound opening 24 opens into the back side cavern 12 under the microphone structure 11. The sound pressure is applied to microphone structure 11 via the back side cavern 12 and the entire interior 25 of housing 20 forms the back side volume for the microphone structure 11. A media exchange between the surroundings and housing interior 25 takes place via leakage path 15 in microphone structure 11.

The assigned ASIC element 41 is likewise mounted on the inner side of cover substrate 23 next to MEMS microphone element 10. The active front side of the ASIC element 41 points into housing interior 25 and is connected on the one hand to MEMS microphone element 10 via wire bonds 61, 62, and on the other hand to conductor paths of cover substrate 23, which are not illustrated in detail in this case. The chip-to-chip wire bond connection 61 is in particular free of leakage current. The electrical contacting of elements 10 and 41 is thus independent of their mechanical fixing on cover substrate 23. Therefore, elements 10, 41 may be glued or soldered to substrate 23.

This also applies with regard to media sensor element 30 which is situated on bottom substrate 21 opposite ASIC element 41 laterally offset to MEMS microphone element 10 and is connected via wire bond 63 to conductor paths (not illustrated here in detail) of bottom substrate 21. ASIC element 42 assigned to media sensor element 30 is positioned next to media sensor element 30 and opposite MEMS microphone element 10. In contrast to media sensor element 30, the ASIC element is mounted face down on bottom substrate 21, i.e., with the active front side facing bottom substrate 21, namely with the aid of solder balls 64, solder bumps, stud bumps, or also copper pillars, via which an electrical connection was also established to the conductor paths of bottom substrate 21. This type of assembly and electrical contacting is particularly space-saving. The space thus gained benefits either a minimization of the component or housing height, or enables the use of thicker microphone elements having a better performance. A minimization of the component height is likewise strived for by using the offset situation of the comparatively thick MEMS elements 10 and 30 and the offset of wire bonds 61, 62, and 63 protruding into housing interior 25. As a further, extremely space-saving option of the element contacting, chip-substrate-wire bonding in connection with conductor paths on the housing substrate should be mentioned.

According to the present invention, the media application of media sensor element 30 takes place via sound opening 24 in housing 20 and via leakage path(s) 15 in microphone structure 11 of MEMS microphone element 10. The opening cross section of leakage paths 15 may be advantageously varied in order to improve, for example, the response behavior of strongly diffusion-driven media sensors. For this purpose, additional individually actuatable structure elements may be provided in the microphone structure. Using a suitable layout of the microphone structure, a change of the opening cross section of leakage paths 15 may, however, also be achieved through mechanical pretensioning of diaphragm 13.

In order to avoid repetitions, only the differences with component 100 will be essentially explained in greater detail in the description of the following exemplary embodiments. Since identical components are provided with the same reference numerals, reference will otherwise be made to the description of FIG. 1.

In contrast to the previously described component 100, component 200 illustrated in FIG. 2 includes only three element components, namely a MEMS microphone element 10, a media sensor element 30, and a shared ASIC element 40 for processing the microphone and sensor signals. These three element components 10, 30, and 40 are situated in a shared housing 20, which is designed exactly like housing 20 of component 100.

As in the case of component 100, MEMS microphone element 10 of component 200 is mounted in cover substrate 23 of housing 20 across sound opening 24 in a pressure-tight manner, so that sound pressure is applied to microphone structure 11 via the back side and the entire interior 25 of housing 20 functions as a back side volume for microphone structure 11. At least one leakage path 15 is also formed in this case in microphone structure 11, via which a media exchange takes place between the surroundings and housing interior 25. According to the present invention, in the case of component 200, the media application of media sensor element 30 also takes place via sound opening 24 in housing 20 and via leakage path(s) 15 in microphone structure 11 of MEMS microphone element 10.

Media sensor element 30 is positioned in this case on the inner side of cover substrate 23 next to MEMS microphone element 10. The two MEMS components 10 and 30 are fixed by gluing or soldering on the back side on cover substrate 23 and connected via chip-substrate-wire bonds 65, 66 to conductor paths of cover substrate 23.

ASIC element 40 is mounted on bottom substrate 21 opposite the two MEMS components 10 and 30 and connected via wire bonds 67 to conductor paths of bottom substrate 21. The microphone and sensor signals are supplied to ASIC element 40 via conductor paths and/or through contacts (not illustrated here in detail) of ring substrate 22.

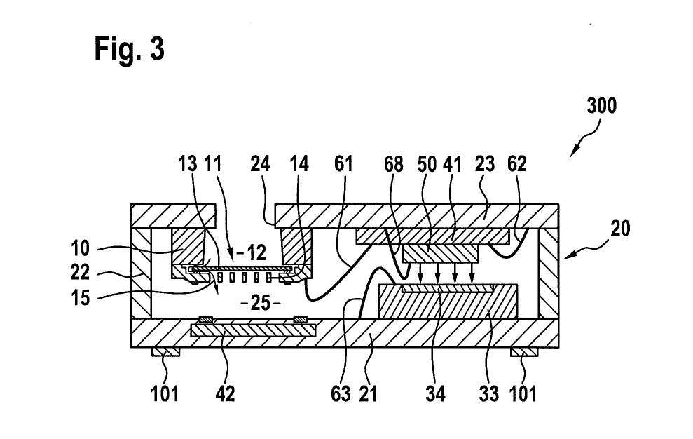

Component 300 illustrated in FIG. 3 includes a MEMS microphone element 10 and a gas sensor element 33 having a gas-active coating 34. An ASIC element 41 or 42 for processing the microphone signals or the sensor signals is respectively assigned to the two MEMS elements 10 and 33. In addition, component 300 also includes a UV diode or an IR heater 50 for heating and/or regenerating gas-active coating 34 of gas sensor element 33. These five element components 10, 33, 41, 42, and 50 are situated in a shared housing 20, which is designed exactly like housing 20 of component 100.

MEMS microphone element 10 of component 300 is also mounted across sound opening 24 in a pressure-tight manner in cover substrate 23 of housing 20, so that sound pressure is applied to microphone structure 11 via the back side, and the entire interior 25 of housing 20 functions as a back side volume for microphone structure 11. At least one leakage path 15 is also formed in this case in microphone structure 11, via which a media exchange takes place between the surroundings and housing interior 25, so that the media application of gas sensor element 33 takes place via sound opening 24 in housing 20 and via leakage path(s) 15 in microphone structure 11 of MEMS microphone element 10.

Gas sensor element 33 is mounted on bottom substrate 21 of housing 20 laterally offset from MEMS microphone element 10 and connected to conductor paths of bottom substrate 21 via wire bonds 63. A chip stack, made up of ASIC element 41 and UV diode 50, is mounted opposite the gas sensor element on the inner side of cover substrate 23 and thus next to MEMS microphone element 10. The UV diode is, according to its purpose, aligned with gas sensor element 31. ASIC element 41 is connected on the one hand to MEMS microphone element 10 via wire bonds 61, 62, and on the other hand to the conductor paths of cover substrate 23. UV diode 50 is also connected to the conductor paths of cover substrate 23 via wire bonds 68. ASIC element 42 assigned to gas sensor element 33 is pressed into a corresponding recess in bottom substrate 21 opposite MEMS microphone element 10 and electrically connected to gas sensor element 33 via through contacts and conductor paths on bottom substrate 21. This type of mounting of ASIC element 42 likewise enables a reduction of the component height or the use of a thicker MEMS microphone element having an improved performance.

Finally, it should be noted that the sound opening does not necessarily have to be formed in the cover substrate of the housing, but rather may be situated at other points of the housing wall, for example, in the bottom substrate. The sound opening may also be implemented in the form of a channel in the housing wall, whose outer opening is situated offset to the opening in the housing interior. In each case, the MEMS microphone element is mounted on the inner side of the housing wall pressure-tight across the sound opening.

The housing of a component according to the present invention may, in general, also be implemented quite differently than previously described. Thus, the housing may be made up, for example, of only two housing parts, a flat housing bottom and a housing cover in the form of an injection molded, hot-stamped, or deep-drawn plastic housing parts, or also a premolded housing part which was shaped using an appropriate tool.

What is claimed is:

1. A component, comprising:
a housing;
at least one MEMS microphone element mounted inside the housing across at least one sound opening in a wall of the housing so that a sound pressure application of a microphone structure of the MEMS microphone element takes place via the sound opening, the housing interior functioning as a back side volume for the microphone structure;
at least one leakage path formed in the microphone structure for a slow pressure equalization between a front side and a back side of the microphone structure; and
at least one further MEMS sensor element situated within the housing, wherein a sensor of the further MEMS sensor element operates in accordance with a media application that takes place via the at least one leakage path in the microphone structure of the MEMS microphone element.

2. The component as recited in claim 1, wherein:
an opening cross section of the at least one leakage path in the microphone structure is variable,
the microphone structure of the MEMS microphone element includes at least one controllable structure element with the aid of which a predefined opening cross section of the at least one leakage path is settable.

3. The component as recited in claim 2, wherein the opening cross section of the at least one leakage path is definitely settable with the aid of a controllable diaphragm of the microphone structure.

4. The component as recited in claim 1, further comprising an arrangement for increasing a pressure equalization flow via the at least one leakage path.

5. The component as recited in claim 4, wherein the arrangement includes an arrangement for at least one of heating and ventilating a controllable structure element.

6. The component as recited in claim 1, wherein the MEMS microphone element and the MEMS sensor element are mounted next to one another on the wall of the housing.

7. The component as recited in claim 1, wherein the MEMS microphone element and the MEMS sensor element are mounted on opposite housing wall sections.

8. The component as recited in claim 7, wherein the opposite wall sections are offset to one another.

9. The component as recited in claim 3, further comprising:
at least one ASIC element situated within one of the housing and the wall of the housing, wherein the ASIC element is electrically connected to at least one of the MEMS microphone element and the MEMS sensor element.

10. The component as recited in claim 9, wherein at least one of the MEMS microphone element, the diaphragm, and the ASIC element is electrically connected at least one of to a wiring level on an inner surface of the wall of the housing and to a further element via at least one of wire bonds and bump contacts.

11. The component as recited in claim 1, wherein at least two elements are mounted in the form of a chip stack in the housing and electrically contacted.

12. The component as recited in claim 1, wherein the at least one MEMS sensor element includes at least one of a pressure sensor, a humidity sensor, and a gas sensor.

13. The component as recited in claim 1, wherein the MEMS sensor element includes at least one gas sensor element having a gas-active coating and within the housing, wherein the housing includes at least one element for irradiating the gas-active coating, the at least one element for irradiating being situated within the housing opposite the gas sensor element.

14. The component as recited in claim 13, wherein the at least one element for irradiating irradiates in one of the UV and the IR range.

15. The component as recited in claim 1, wherein:
the housing includes a bottom substrate, a ring substrate, and a cover substrate that are connected pressure-tight to one another,
the bottom, ring, and cover substrates are duroplastic plastic substrates that are equipped with electrical path structures, conductive paths, and through contacts, so that the cover substrate and the ring substrate are also electrically connected to the bottom substrate, and wherein through contacts are provided in the bottom substrate for an external electrical contacting of the component via path structures on a back side of the bottom substrate.

16. The component as recited in claim 15, wherein the bottom, ring, and cover substrates, are printed circuit boards.
